(19) United States
(12) Patent Application Publication
(10) Pub. No.: US 2008/0108332 A1
(43) Pub. Date: May 8, 2008

(54) METHOD AND SYSTEM FOR SUBSCRIBING FOR PRESENCE INFORMATION

(76) Inventors: Linyi TIAN, Shenzhen (CN); Yang Zhao, Shenzhen (CN); Qian Sun, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/953,141

(22) Filed: Dec. 10, 2007

Related U.S. Application Data
(63) Continuation of application No. PCT/CN2006/002520, filed on Sep. 25, 2006.

(30) Foreign Application Priority Data
Sep. 30, 2005 (CN) 200510107430.4

(51) Int. Cl. H04Q 7/38

(52) U.S. Cl. 455/414.1

(57) ABSTRACT

A method for subscribing for presence information, wherein: a delegated watcher client or an application server sends a subscription message of a watcher client to a presence server; when determining that the subscription message is a delegated subscription, the presence server processes the message according to delegation authorization rules; when determining that the subscription message is a non-delegated subscription, the presence server processes the message in non-delegated subscription mode; and the presence server saves the subscription relation obtained by processing the message. The present invention further provides a system for subscribing for presence information and a presence server. By employing the present invention, the subscription mode of the presence information may be made more flexible.

The present application is a continuation of PCT application PCT/CN2006/002520, filed on Sep. 25, 2006, entitled “A METHOD, SYSTEM FOR SUBSCRIBING PRESENCE INFORMATION”, which is incorporated by reference herein in its entirety.

### FIELD OF THE INVENTION

The present invention relates to a method and a system for subscribing for presence information, in particular, to a method and a system with a delegation mechanism for subscribing for presence information.

### BACKGROUND OF THE INVENTION

At present, the application range of Presence Service becomes wider and wider. Presence Service is a kind of communication service in which presence information is collected and published. Perhaps many people want to obtain the presence information of a user of presence service referred to as presentity. These people may be folks and friends of the presentity, and strangers may also want to obtain the presence information of the presentity. However, a lot of presence information may be privacy for the presentity. Presence service allows the user to find a partner to chat, inquire state information and the like of the partner, and implement instant intercommunion of text and multimedia information, without limitations of space and time. The presence and management of user state is accomplished by a Presence Server. According to the presence information, the user referred to as watcher may obtain information such as whether the other party is online, what is the other party doing (such as having a meeting and dining), mood, capability of the client and hobbies. A user may share media content such as ringing tone, picture and file, with other users by sending an invitation.

FIG. 1 describes a system for realizing the presence service in the prior art, including: a presentity client (a presentity client or an application server), a presence server, watcher client A (a watcher client or an application server) and a presence XML Document Management System (XDMS); the presence server includes a presence information compose and publish device, and a presence information subscription processing device.

The presentity client is a presence information source. When the presence information changes, the presentity client initiatively sends a publish message to the presence server and publishes the presence information.

The presence information subscription processing device is responsible for receiving a subscription message from watcher client A, determining a subscription result according to subscription authorization rules preset by the subscribed presentity, and saving the subscription relation (the mode in which the subscription is only processed by a presence information subscription processing device is referred to as a non-delegated subscription mode).

The presence information compose and publish device receives and processes the publish message from the presentity client, and finally sends the presence information to watcher client A via a notification message.

Watcher client A subscribes for the presence information of the presentity and receives the notification message from the presence server.

Presence XDMS saves the authorization rules (subscription authorization rules, content authorization rules, etc.), the presentity group and so on.

Watcher client A and presentity client may be mobile terminals, such as a mobile phone, a Personal Digital Assistant (PDA), and an intelligent terminal (such as digital Set-Top Box); or, fixed terminals. The above functions of mobile terminals may also be applied to fixed terminals. At present, fixed terminals with Session Initiation Protocol (SIP) functions are also implemented. The presentity client has an application for processing a subscription message. A user may select the information to be subscribed for, and after confirmation, watcher client A or the presentity client sends all messages including the user identifier to the presence server.

In the above solution, subscribe messages and publish message are both SIP messages. The field “From” in the SIP message header of the message is an identity flag of the watcher, and “TO” represents the identity flag of the presentity. If the message body is null, all presence information of the presentity is subscribed. The message body may include a XML document adapted to describe which presence information of the presentity is subscribed for. In the existing mechanism, subscription authorization rules are described by an XML document including elements <Condition>, <Action> and <Transformation>. Element <Condition> represents matching conditions and includes: 1) Identity: a user identity flag, such as “sip: zhangsan@163.com”; 2) Domain, such as “@163.com”. For a user meeting <Condition>, after the user subscribes for the presence information successfully, the presence information (such as activity state: having a meeting, dining, etc.) may be published to the user. Element <Action> represents the action to be employed after matching and mainly includes: allowing, blocking, polite-blocking (a Subscription Successful message is returned in this process, but no presence information will be notified to the watcher, i.e. the watcher is blocked politely, and the effect is the same as that of “block”) and confirming. Element <Transformation> indicates which information is allowed to be published to the watcher after the watcher subscribes for the presence information successfully, and is only executed when the information is published, irrelevant to the subscription authorization.

In the above solution, the presence XDMS is separated from the presence server. Various rules are saved on the presence XDMS. The presentity client configure and modify various rules on the presence XDMS via an Aggregation Proxy, or the application server directly uses the XCAP protocol, or the user uses a human-machine interaction interface (such as a web page) through an XCAP protocol. In the prior art, the presence XDMS may also be combined with the presence server, and various rules are saved in the presence server.

The process of the prior art solution will now be described in detail in conjunction with FIG. 2.

1) The presentity client first needs to perform some configurations on the presence XDMS (for example, subscription authorization rules including which users are allowed to subscribe and content authorization rules including which information is allowed to be published etc.). The presence server may obtain these rules via the XCAP protocol, or, if the presence server subscribes for change notification of these rules, when these rules change, the presence XDMS may notify the presence server. The subscription authorization rules and content authorization rules are saved in an XML file. The XML file includes three important elements <Condition>, <Action> and <Transformation>. <Condition> represents matching condition and <Action> represents matching result (allow, block, polite-block and confirm). The combination of <Condition> and <Action> corresponds to the subscription authorization rules for processing the subscription request of a watcher client according to the rules configured by the presentity client. <Transformation> corresponds to the content authorization rules for filtering information which is not allowed to be published according to the rules (which information is allowed to be published for a certain watcher client) configured by the presentity client.

2) Watcher A requests the presence server to subscribe for the presence information of the presentity.

3) The presence information subscription processing module in the presence server performs matching according to the subscription authorization rules in the presence XDMS, if the condition specified in <Condition> element is matched, the subscription is allowed and the subscription relation is saved.

4) The presentity publishes the information to the presence server.

5) The presence information compose and publish device in the presence server sends a notification of the presence information to watcher A after processing according to a series of rules saved in the presence XDMS.

In the prior art, the subscriber of the presence information must be the watcher, so it is not flexible and the experience of the user is poor. It cannot be implemented in the prior art that a user wants to delegate other people to subscribe for the presence information (for example, watcher client A consigns watcher client C to subscribe for the presence information). When a user uses a certain application server, the user can not delegate the application server to subscribe for the presence information (for example, when the user plays a game, the user needs to subscribe for the information of the playmate), so the user needs to log on another program to subscribe for the information, hence the experience is poor and inflexible. When a user uses some unfamiliar services, the user does not know which presence information the presentity, related to the service, has, so the content of the presence information is limited, and the service lacks presence information and is difficult to use. The above inconvenience may be eliminated if a delegated subscription is implemented.

### SUMMARY OF THE INVENTION

In view of the above problems of the prior art, the present invention provides a method and a system for subscribing for presence information, so that the subscription of the presence information becomes more flexible and simpler, and the experience of the user may be improved.

Therefore, the present invention provides a method for subscribing for presence information, including:

sending, by a delegated watcher client or an application server, a subscription message to a presence server;

determining, by the presence server, that the subscription message is a delegated subscription message; and processing the subscription message according to delegation authorization rules.

Moreover, the delegation authorization rules include the delegated subscription authorization rules adapted to determine which delegated subscription mode is to be employed to process the subscription message.

Furthermore, the delegated subscription authorization rules include block rules and a presence server default policy.

Furthermore, the delegation authorization rules include delegated subscription content authorization rules, and the delegated subscription content authorization rules include at least one of personal delegated subscription content authorization rules, common delegated subscription content authorization rules and default rules, or a combination thereof.

Moreover, determining that the subscription message is a delegated subscription by the presence server includes:

the presence server determines that the subscription message is the delegated subscription, if the identity of the user that sends the subscription message is different from the identity of the subscriber; or determining, by the presence server, that the subscription message is a delegated subscription, if a field for indicating the delegated subscription mode is configured in the subscription message.

Moreover, processing the subscription message according to the delegation authorization rules includes: waiting, for the delegating party to confirm the subscription, if the presence server determines that the subscription message needs to be confirmed by a delegating party.

Moreover, processing the subscription message according to the delegation authorization rules includes: determining, by the presence server, that the subscription message needs to be blocked; and blocking the subscription.

Moreover, the method further includes: saving, by the presence server, a subscription relation obtained by processing the message.

Moreover, processing the subscription message according to the delegation authorization rules includes: determining by the presence server, that the subscription message needs to be blocked; and blocking the subscription.

In addition, the present invention further provides a system for subscribing for presence information, including a watcher client, a presence server and a presence XML document management system, wherein the system further comprises a delegated watcher client;

the delegated watcher client, adapted to send a subscription message of the watcher client to the presence server;

the presence server, adapted to process the subscription message of a delegated subscription according to delegation authorization rules; and the delegation authorization rules are configured by the watcher client in the presence server or the presence XML document management system.

Moreover, the presence server includes:

a delegation checking and processing device, adapted to receive the subscription message sent by the watcher client or the application server, determine the subscription message is in a delegated subscription mode, determine that the delegated subscription message is according to the delegation authorization rules, and send the delegated subscription message; and

a presence information subscription processing device, adapted to process the delegated subscription message according to configured rules and save a processed subscription relation.

Moreover, the delegation checking and processing device is further adapted to perform a confirmation process when the received subscription message needs to be confirmed by the delegating party.

Moreover, the delegation checking and processing device is further adapted to block the subscription message if the subscription message needs to be blocked.

Moreover, the delegation checking and processing device is further adapted to process the subscription message according to at least one of personal delegated subscription content authorization rules, common delegated subscription content authorization rules and default rules.

In addition to the above method and system for subscribing for presence information, the present invention further provides a presence server including a presence information subscription processing device, and the presence server further includes:

a delegation checking and processing device, adapted to receive a subscription message, and determine that the subscription message is in a delegated subscription mode; and determine that the delegated subscription message is allowed according to delegation authorization rules, and send the subscription message to the presence information subscription processing device.

Moreover, the delegation checking and processing device is further adapted to perform a confirmation process when the received subscription message needs to be confirmed by the delegating party.

Moreover, the delegation checking and processing device is further adapted to block the subscription message when the received subscription message needs to be blocked.

Moreover, the delegation checking and processing device is further adapted to process the subscription message according to at least one of personal delegated subscription content authorization rules, common delegated subscription content authorization rules and default rules.

By employing the above technical solutions of the present invention, a user may delegate other user or other application server to subscribe for presence information, and the user may subscribe for the presence information during using application, hence the user does not need to log on a special application to subscribe for the presence information. Therefore, the subscription of the presence information becomes more flexible, and the user does not need to deeply understand a certain service and remember the complex presence information the service has. The service may provide a human-machine interaction interface and display the presence information to the user for selection, so that the difficulty for subscribing for presence information by a user may be reduced.

### BRIEF DESCRIPTION OF THE DRAWINGS

FIG. 1 is a structural diagram of a system for realizing a presence service of the prior art;

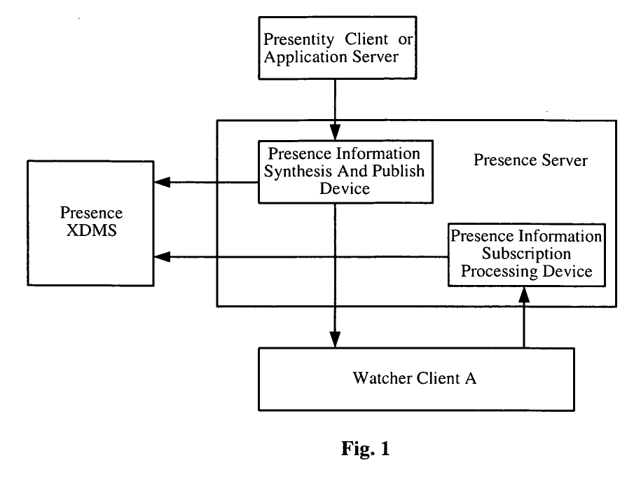

FIG. 2 is a flow chart of a conventional solution;

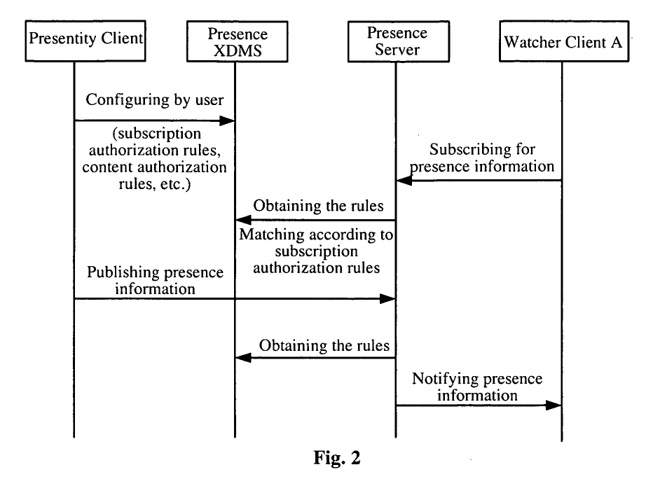

FIG. 3 is a structural diagram of a system according to an embodiment of the present invention;

FIG. 4 is a flow chart of a subscription and publish process according to an embodiment of the present invention; and

FIG. 5 is a flow chart of a process for executing delegated subscription authorization rules and delegated subscription content authorization rules according to an embodiment of the present invention.

### DETAILED DESCRIPTION OF THE EMBODIMENTS

The present invention will now be further illustrated in conjunction with the drawings.

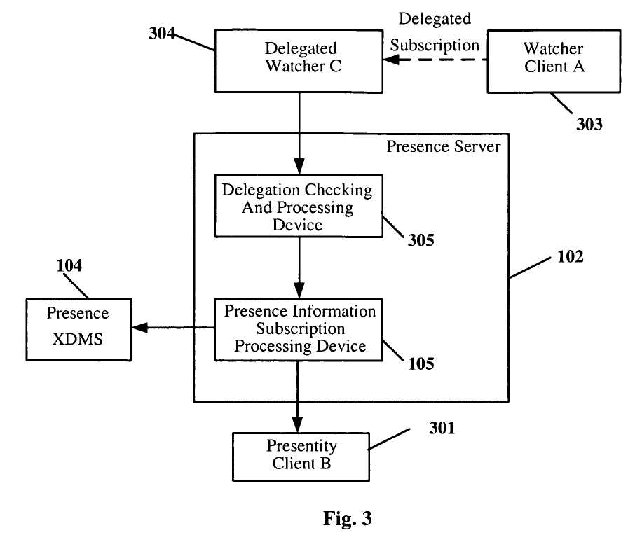

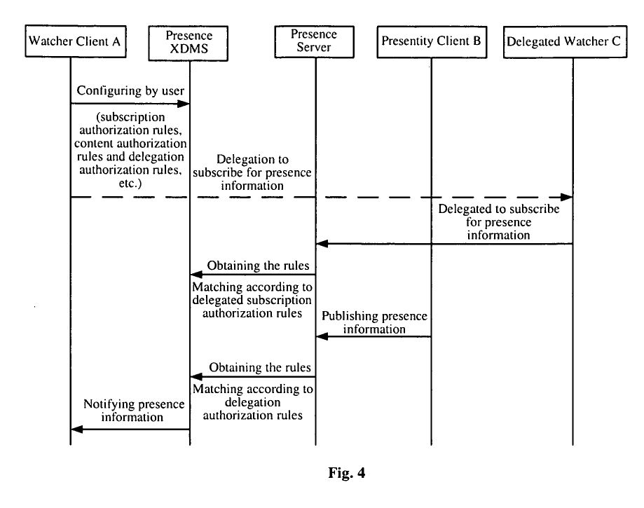

Referring to FIG. 3, an system includes watcher client A303, delegated watcher client C304 (a watcher client or an application server), presence server 102, presentity client B301 and presence XDMS 104, and presence server 102 includes delegation checking and processing device 305 and presence information subscription processing device 105. Referring to FIG. 4, the specific subscription and publish process is as follows.

1) Watcher client A303 performs some configurations in presence XDMS 104 in advance (for example, subscription authorization rules including which users are allowed to subscribe, content authorization rules including which information is allowed to be published and delegation authorization rules including: delegated subscription authorization rules for specifying whether the delegated subscription is allowed and delegated subscription content authorization rules for specifying what content is allowed for the delegated subscription, etc.).

2) Watcher client A303 assigns watcher client C304 to subscribe for the presence information of presentity B301.

3) Watcher client C304 sends a delegated subscription request to delegation checking and processing device 305 of the presence server, for requesting to subscribe for presence information of presentity B 301 for watcher A303. Delegation checking and processing device 305 performs the following operations.

a) Delegation checking and processing device 305 checks whether a subscription message is in a delegated subscription mode (i.e. whether the subscriber subscribes for the presence information for others).

b) If the subscription message is in a non-delegated subscription mode, proceeds to process f); if the subscription message is in the delegated subscription mode, proceeds to process c).

c) Delegation checking and processing device 305 obtains delegated subscription authorization rules and delegated subscription content authorization rules from the presence XDMS (each rule may be obtained in or before this process in which the rule is applied).

d) Delegation checking and processing device 305 determines whether the delegated subscription is allowed according to the delegated subscription authorization rules.

e) Delegation checking and processing device 305 determines what content is allowed for the delegated subscription according to the delegated subscription content authorization rules.

f) Delegation checking and processing device 305 sends the subscription message to presence information subscription processing module 105.

g) Presence information subscription processing module 105 processes the subscription message according to the subscription authorization rules configured by presentity B301, and saves the subscription relation (for example, A subscribes for the location information of B).

4) Presentity B 301 publishes the presence information to presence server 102; for example, a chief assigns a secretary; a user uses a certain service (such as logging on a game server); or a button is clicked to trigger a delegated publish process.

5) Presence server 102 processes the presence information according to publish rules and a subscription relation, and sends a notification to watcher A303.

In this embodiment, operations of delegation checking and processing device 305 are all optional.

For obtaining various rules by delegation checking and processing device 305, these rules may be obtained by the presence server via the XCAP protocol, or if the presence server subscribes for the change notification of these rules, when these rules change, the presence XDMS will notify the presence server. These rules may be obtained by the delegation checking and processing device from the XDMS via the XCAP protocol; or, a public module, adapted to obtain rules from the XDMS and provide rules to other modules, may also be configured in the presence server; or, the rules may be directly saved in the presence server. It should be appreciated by those skilled in the art that in the present invention, each device may obtain the corresponding rules with the above mode.

In this embodiment, the application server includes a game server or a server which has similar functions, and an instant message server (such as ICQ/MSN server) may also be included.

In the above embodiment, a process in which the presence information is subscribed in a delegated mode is described. The delegated subscription mode and the existing subscription mode may be combined in the presence server, and it is determined which mode may be used by a delegation check process. When a device for delegation check referred to as delegation checking and processing device receives a subscription message, the delegation checking and processing device first determines whether the subscription message is in delegated subscription mode. If the subscription message is not in the delegated subscription mode, the delegation checking and processing device processes the subscription message according to the existing process; if the subscription message is in the delegated subscription mode, delegation authorization rules (including: delegated subscription authorization rules (whether the delegated subscription is allowed) and delegated subscription content authorization rules (what content is allowed for the delegated subscription)) is obtained from the presence XDMS.

The following methods may be used for determining whether the subscription message is a delegated subscription.

Method 1: The identity of the user which sends the subscription message and the identity of the subscriber of the presence information (watcher) are obtained from subscription message header, and then the identities are compared. If the identities are the same, the subscription message is not in the delegated subscription mode; if the identities are different from each other, the subscription message is in the delegated subscription mode. Field <From> in the subscription message header represents the user who subscribes for the presence information (the delegating party); field <To> represents the presentity; and field <P-Asserted-Identity> represents the identity of the user who sends the message (the delegated party). If <From> and <P-Asserted-Identity> are the same with each other, the subscription message is in the non-delegated mode; otherwise, the subscription message is in the delegated mode. The fields <From>, <To> and <P-Asserted-Identity> may be at any location of the subscription message, as long as the presence server may detect the subscription message according to a preconfigured protocol.

Method 2: A field indicating the delegated subscription may be added to the subscription message (message header or message bogy), such as field “Delegation”, to indicate the identity flag of the delegating party and the delegated subscription mode. However, it is apparent to those skilled in the art that this field may be put in any location of subscription message when the subscription message is sent, as long as the presence server may detect the subscription message according to a preconfigured protocol. Moreover, the field may be configured as a field of any types.

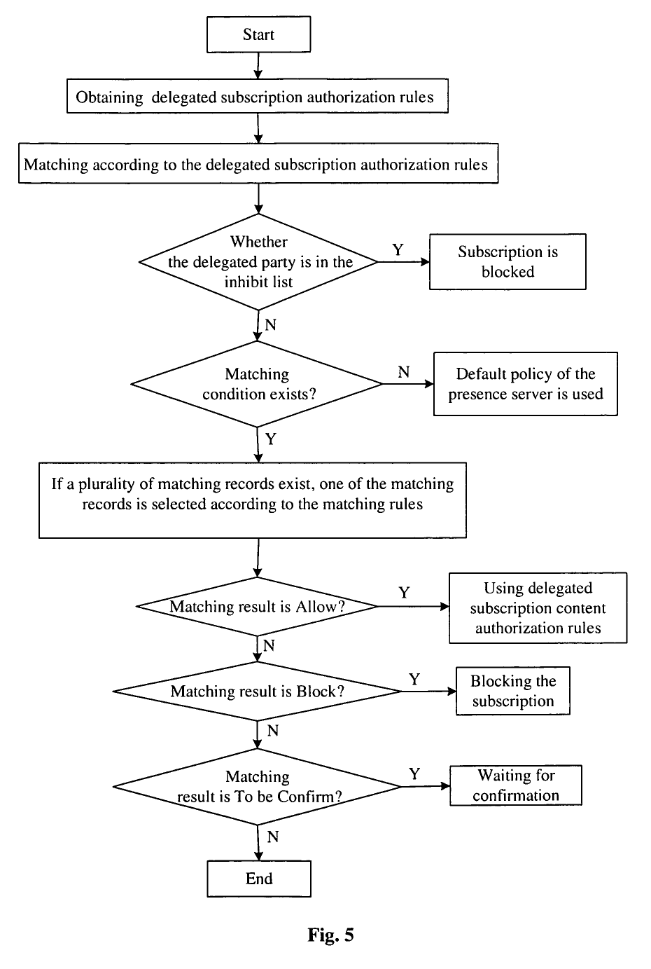

The process for performing the delegated subscription authorization rules and the delegated subscription content authorization rules will now be illustrated in detail below. Referring to FIG. 5, the specific process is as follows.

1) After delegation checking and processing device 305 receives a subscription message, delegation checking and processing device 305 obtains delegated subscription authorization rules from presence XDMS 104, and matches the subscription message and the delegated subscription authorization rules according to the delegated subscription authorization rules.

2) Delegation checking and processing device 305 determines whether the sending party (the delegated party) has matching item in block rules, if the sending party has matching item in block rules, blocks the subscription; if the sending party does not have matching item in block rules, proceeds to process 3.

3) Delegation checking and processing device 305 determines whether the sending party not in the block rules has a matching item in the delegated subscription authorization rules, if the sending party not in the block rules does not have a matching item in the delegated subscription authorization rules, the default policy of the presence server is used (for example, all of the presence information may be blocked or subscribed); if the sending party not in the block rules has a matching item in the delegated subscription authorization rules, proceeds to process 4).

4) Delegation checking and processing device 305 determines whether a plurality of matching items exist, if yes, selects the matching items according to a selection rules (such as Priority).

5) Delegation checking and processing device 305 indexes a result corresponding to the matching item in the delegated subscription authorization rules, if the result is Not Allowed, proceeds to process 6); otherwise, the delegated subscription content authorization rules are used. The “delegated subscription content authorization rules” is used to limit which presence information may be subscribed for by the delegated party. For example: Zhangsan delegates a game server only to subscribe for the game presence information of a user who plays the game, if the game server subscribes for the information “location+game” of the presentity, only the subscription of “game” is finally saved in the subscription relation.

6) If a determination result is Polite-Block, the subscription is blocked politely; otherwise, proceeds to the next process.

7) If the determination result is To be Confirmed, the confirmation process is performed (the delegating party may select a delegated subscription content authorization rule, a common delegated subscription content authorization rule, a certain personal delegated subscription content authorization rule, or may directly select the content item allowed to be subscribed for, or may block).

The enactment of various rules may be controlled flexibly according to personal requirements. The above listed rules are determined by matching the message field or identity related to each rule.

Each of the above operation processes and the enactment of various rules concerned may be easily implemented by those skilled in the art according to the existing programming method.

For better understanding, several specific delegated subscription authorization rules and delegated subscription content authorization rules are listed. First of all, a delegated subscription authorization rule needs to be matched, including: searching block rules and a matching record list, and the matching record list includes the personal identity (which refers to the matching according to the specific personal identity, such as Zhangsan and Lisi, specifically) and the common identity (which refers to the matching via an identity with a common feature, such as *@163.com, rather than a specific person); and a corresponding process is performed according to the search result.

If the matching identity is found in the block rules, then the subscription is blocked.

If the rules corresponding to the search result are Allowed, a identity corresponding to Allowed is matched in the delegated subscription content authorization rules, and the delegated subscription content authorization rules corresponding to the matching result are used for processing.

If a rule corresponding to the search result is Polite-Block, the subscription is blocked politely.

If a rule corresponding to the search result is To be Confirmed, a confirmation process is performed.

The delegated subscription content authorization rules include personal delegated subscription content authorization rules and common delegated subscription content authorization rules, and the personal delegated subscription content authorization rules correspond to a personal identity and the common delegated subscription content authorization rules correspond to a common identity. Information subscription content or subscription range satisfying the corresponding rules may be established. For example, it is assumed that the presentity is user Lisi, the delegating party is Tianlinyi, and the delegated party is Zhangsan. The delegating party Tianlinyi delegates Zhangsan to subscribe for the location presence information of Lisi, and Zhangsan sends a subscription request to subscribe for the “location+game” presence information of Lisi. The delegation authorization rules of user Tianlinyi and the subscription authorization rules of presentity Lisi are as follows:

1. block rules: liming@163.com
chen@163.com

2. Matching record rules:

| Delegated party ID | Result | Priority |
|---|---|---|
| zhangsan@163.com | Allow | 1 |
| *@163.com | Block | 2 |
| chenrui@163.com | Allow | 1 |
| macy@future.com | To be Confirmed | 1 |
| Default | Polite-Block | 1 |

3. Delegated subscription content authorization rules:

| | Location | Game | |
|---|---|---|---|
| Delegated party ID | Information | Information | Priority |
| zhangsan@163.com | Block | Allow | 1 |
| *@163.com | Allow | Block | 2 |
| default | Block | Block | 3 |

4. Subscription authorization rules of the presentity Lisi:

| Subscriber | Result |
|---|---|
| tianlinyi@163.com | Allow |
| wangwu@163.com | Block |

Referring to the block rules, the subscription authorization rules and the content authorization rules, several examples of the user subscription message are given below.

1) If liming@163.com subscribes for the presence information for Tianlinyi, because liming@163.com is in the block rules, the subscription is blocked.

2) If zhangsan@163.com subscribes for the presence information for Tianlinyi, the personal and common subscription authorization rules are both involved in matching record table when matching the subscription authorization rules, and the matching result is that the priority of an person is high and the result of an person is Allow, then the personal identity “zhangsan@163.com” is matched in the delegated subscription content authorization rules, and the matching result is that the game information is allowed to be subscribed according to the delegated subscription content authorization rules corresponding to “zhangsan@163.com”. When Zhangsan sends a subscription request, for subscribing for the “location+game” presence information of Lisi. Because only the game information is allowed to be subscribed according to the delegated subscription content authorization rules, the result according to the delegated subscription authorization rules are as follows: Zhangsan is allowed to subscribe for the presence information for Tianlinyi via delegation, and only the subscription request of game-related presence information is sent to the next device.

The subscription request sent in the previous step is processed according to the authorization rules of presentity Lisi, and the result is: the delegating party Tianlinyi is allowed to subscribe for the presence information of Lisi, and the subscription relation is that Tianlinyi only subscribes for game presence information. When the presentity Lisi publishes the game presence information, Lisi sends the game presence information to Tianlinyi according to the subscription relation (accurate matching employed in this embodiment: if identity zhangsan@163.com does not exist in the delegated subscription content authorization rules, the rules corresponding to identity “*@163.com” will be used for processing, in other words, only location information is allowed to be sent; if neither of the rules exists, a default rule will be used, such as Block).

3) If tiantian@163.com subscribes for the presence information for Tianlinyi, the matching result is a common identifier when searching the matching record rules in the delegated subscription authorization rules, and a corresponding rule is Block, then the subscription is blocked.

4) If chenrui@163.com subscribes for the presence information for Tianlinyi, the matching identity in the delegated subscription authorization rules are a personal ID, and the corresponding rules are Allow; the personal identity chenrui@163.com is matched in the delegated subscription content authorization rules and the matching result is “*@163.com” and the corresponding rules are “It is allowed to subscribe for the location information”. Similarly, after processing by the authorization rules of presentity Lisi, the delegating party Tianlinyi is allowed to subscribe for the presence information of Lisi, and in the subscription relation, it will be saved that Tianlinyi only subscribes for location-related presence information.

5) If Iuojun@future.com subscribes for the presence information for Tianlinyi, because no matching identity exists in the delegated subscription authorization rules (block rules and matching record rules), it may be politely blocked according to the default policy of the presence server.

6) If macy@future.com subscribes for the presence information for Tianlinyi, a matching identity exists in the delegated subscription authorization rules, but the rules corresponding to the identity is To be Confirmed, then a confirmation process is performed.

The structure of the presentity client or watcher client according to an embodiment of the present invention and the corresponding process will now be described for the method of the present invention.

A delegated subscription processing module is added in the presentity client or watcher client according to an embodiment of the present invention, and the presentity client performs the following process:

1) inquiring whether a presence information subscription entity (the watcher client sending a subscription message) employs a delegated subscription;

2) if the delegated subscription is employed, indicating the delegated subscription mode in the subscription message, for example, adding a delegated subscription field to the subscription message header.

Optionally, the field may not be added to the subscription message in case of the delegated subscription. Instead, the user identity of sending the subscription message and the user identity of subscribing for the presence information may be sent and then determined by the presence server, or a field representing delegated subscription mode may also be added.

While the present invention has been illustrated and described with reference to some preferred embodiments, the present invention is not limited to these. Those skilled in the art should recognize that various variations and modifications may be made without departing from the spirit and scope of the present invention as defined by the accompanying claims.

1. A method for subscribing for presence information, comprising:
sending, by a delegated watcher client or an application server, a subscription message to a presence server;
determining, by the presence server, that the subscription message is a delegated subscription message; and, processing the subscription message according to delegation authorization rules.

2. The method according to claim 1, wherein the delegation authorization rules comprises delegated subscription authorization rules adapted to determine which delegated subscription mode is to be employed to process the subscription message.

3. The method according to claim 2, wherein the delegated subscription authorization rules comprise block rules and a default policy of a presence server.

4. The method according to claim 2, wherein the delegation authorization rules further comprise delegated subscription content authorization rules, and the delegated subscription content authorization rules comprise at least one of personal delegated subscription content authorization rules, common delegated subscription content authorization rules and default rules or a combination thereof.

5. The method according to claim 2, wherein determining, by the presence server, that the subscription message is a delegated subscription message comprises:
determining, by the presence server, that the subscription message is the delegated subscription message, if an identity of a user sending the subscription message is different from an identity of a subscriber; or
determining, by the presence server, that the subscription message is a delegated subscription, if a field for indicating the delegated subscription mode is configured in the subscription message.

6. The method according to claim 4, wherein processing the subscription message according to the delegation authorization rules comprises:
waiting for the delegating party to confirm the subscription, if the presence server determines that the subscription message needs to be confirmed by a delegating party.

7. The method for subscribing for presence information according to claim 3, wherein processing the subscription message according to the delegation authorization rules comprises:
determining, by the presence server, that the subscription message needs to be blocked; and blocking the subscription.

8. The method for subscribing for presence information according to claim 1, further comprising: saving, by the presence server, a subscription relation obtained by processing the message.

9. The method for subscribing for presence information according to claim 4, wherein processing the subscription message according to the delegation authorization rules comprises:
determining by the presence server, that the subscription message needs to be blocked;
and blocking the subscription.

10. A system for subscribing for presence information, comprising a watcher client, a presence server and a presence XML document management system, wherein the system further comprises a delegated watcher client;
the delegated watcher client, adapted to send a subscription message of the watcher client to the presence server;
the presence server, adapted to process the subscription message of a delegated subscription according to delegation authorization rules;
wherein the delegation authorization rules are configured by the watcher client in the presence server or the presence XML document management system.

11. The system according to claim 10, wherein the presence server comprises:
a delegation checking and processing device, adapted to receive the subscription message sent by the watcher client or the application server, determine the subscription message is in a delegated subscription mode, determine a delegated subscription message is according to the delegation authorization rules, and send the delegated subscription message; and
a presence information subscription processing device, adapted to process the delegated subscription message according to configured rules and save a processed subscription relation.

12. The system according to claim 11, wherein the delegation checking and processing device is further adapted to perform a confirmation process if the received subscription message needs to be confirmed by the delegating party.

13. The system according to claim 11, wherein the delegation checking and processing device is further adapted to block the subscription message if the subscription message needs to be blocked.

14. The system according to claim 11, wherein the delegation checking and processing device is further adapted to process the subscription message according to at least one of personal delegated subscription content authorization rules, common delegated subscription content authorization rules and default rules.

15. A presence server, comprising a presence information subscription processing device, wherein the presence server further comprises:
a delegation checking and processing device, adapted to receive a subscription message, and determine the subscription message is in a delegated subscription mode; and determine that the delegated subscription message is allowed according to delegation authorization rules, and send the subscription message to the presence information subscription processing device.

16. The presence server according to claim 15, wherein the delegation checking and processing device is further adapted to perform a confirmation process if a received subscription message needs to be confirmed by the delegating party.

17. The presence server according to claim 15, wherein the delegation checking and processing device is further adapted to block the subscription message if a received subscription message needs to be blocked.

18. The presence server according to claim 15, wherein the delegation checking and processing device is further adapted to process the subscription message according to at least one of personal delegated subscription content authorization rules, common delegated subscription content authorization rules and default rules.
